(19) United States
(12) Patent Application Publication
(10) Pub. No.: US 2026/0035991 A1
(43) Pub. Date: Feb. 5, 2026

(54) SECURITY DOOR APPARATUS AND METHOD

(71) Applicant: David Copeland, San Diego, CA (US)

(72) Inventor: David Copeland, San Diego, CA (US)

(21) Appl. No.: 19/291,570

(22) Filed: Aug. 5, 2025

Related U.S. Application Data
(60) Provisional application No. 63/679,362, filed on Aug. 5, 2024.

(51) Int. Cl. E06B 7/32

(52) U.S. Cl. CPC E06B 7/32

(57) ABSTRACT

A security door apparatus for a structure including one or more frame portions having sidewalls and a removeable gate. The gate portion can be removably couplable to the sidewalls. Frame portions can include a sliding mechanism and locking mechanism. The door portion can include a first side wall and a second sidewall with an intermediate portion formed between the first and second sidewall. The intermediate portion can be hingedly coupled to one or both of the sidewalls. The apparatus is configured to be placed over an existing pet door for adding extra security. The removeable gate configured to slide up and down and can be locked and unlocked by moving the locking tab between an open and closed position.

### CROSS REFERENCE TO RELATED PATENT APPLICATIONS

This application claims priority to and the benefit of U.S. Provisional Patent Application No. 63/679,362 filed Aug. 5, 2024, the entire disclosure of which is incorporated herein by reference.

### FIELD OF THE INVENTION

The invention relates generally to a security door apparatus and method. More particularly, the invention relates to a security door attachment for a pet door.

### BACKGROUND

Currently there are a number of solutions for a pet security door. One of these solutions attempts to use a standard flexi pet door with a hard cover slide door placed over the flexi door, but this solution fails to meet the needs of the market because the user has to manually slide the hard cover door for extra security. Besides, hard plastic covers can be easily kicked out or pried out. Another solution attempts to use a plastic pet door system with an internal lock, but this solution is similarly unable to meet the needs of the market because those doors are also manually operated and generally tend to only open one way.

It would be advantageous to have an improved apparatus that can be placed over an existing pet door for additional security. Furthermore, it would also be advantageous to have an apparatus that allows the user to open the door by sliding the attachment up and/or swinging the attachment open. Still further, it would be advantageous to have an apparatus that can be easily and fully locked/unlocked. The apparatus of the present disclosure can fulfill an unmet need by providing a pet door attachment.

### BRIEF SUMMARY OF THE INVENTION

In one aspect, a pet door attachment apparatus of the present disclosure can include sidewalls, a removeable gate, a locking tab, a sliding mechanism, and a locking mechanism. This apparatus is usable for preventing any intrusion in a home having a pet gate, which can include possible threats and wildlife encounters.

In another aspect, the present disclosure provides for a security door apparatus for an opening to a structure. The apparatus can include a gate portion, wherein the gate portion comprises a first sidewall, a second sidewall, and an intermediate portion positioned between the first sidewall and second sidewall. A first frame portion, can have a first end, a second end, and a flange portion, wherein the first end and second end define the length of the first frame portion. A second frame portion can have a first end, a second end, and a flange portion, wherein the first end and second end define the length of the first frame portion. A first wall mount cover and a second wall mount cover can be configured to mount respectively to the first frame portion and the second frame portion. The covers can be removably coupled from the frame portions. The first frame portion can be positioned on a first side of the opening and coupled to the structure and the second frame is positioned on a second side of the opening and coupled to the structure. The gate portion can be removably coupled to the first frame portion and second frame portions can be configured to move between a first position and a second position on a vertical axis. The first position can be a lowered position, and the second position can be a raised position. The first frame portion can include a first sliding assembly, and the second frame portion can include a second sliding assembly. A first side of the first sliding assembly is removably coupled to a first side of the first frame portion and the second side of the first sliding assembly is removably coupled to the first sidewall of the gate portion, and wherein a first side of the second sliding assembly is removably coupled to a first side of the second frame portion and the second side of the second sliding assembly is removably coupled to the second sidewall of the gate portion. An intermediate portion of the gate portion can be hingedly coupled to a first sidewall of the gate portion on at least one side. The intermediate portion is configured to swing around a vertical axis. The sliding assembly can include a first track portion is coupled to the sidewall of the cavity of the frame portion and the third track portion is coupled to a sidewall of the gate portion. A second track portion is at least partially housed within the first track portion and the third track portion is at least partially housed within the second track portion.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

A more complete understanding of the present technology may be derived by referring to the detailed description and claims when considered in connection with the following illustrative figures. In the following figures, like reference numbers refer to similar elements and steps throughout the figures.

FIG. 1A is a front view of an exemplary embodiment of an apparatus of the present disclosure.

FIG. 1B is a side view of an exemplary embodiment of an apparatus of the present disclosure.

FIG. 1C is a rear view of an exemplary embodiment of an apparatus of the present disclosure.

FIG. 1D is a top view of an exemplary embodiment of an apparatus of the present disclosure.

FIG. 1E is a perspective view of an exemplary embodiment of an apparatus of the present disclosure.

FIG. 1F is an exploded perspective view of an exemplary embodiment of an apparatus of the present disclosure.

FIG. 1G is a partially exploded perspective view of an exemplary embodiment of a first frame portion, cover portion, and track portion of an apparatus of the present disclosure.

FIG. 2A is a front view of an exemplary embodiment of an apparatus of the present disclosure coupled around an entry point of a structure with the gate in a first position.

FIG. 2B is an enlarged top perspective view of an exemplary embodiment of an apparatus of the present disclosure coupled around an entry point of a structure.

FIG. 2C is a front view of an exemplary embodiment of an apparatus of the present disclosure coupled around an entry point of a structure with the gate in a second position.

FIG. 2D is an enlarged side perspective view of an exemplary embodiment of a track portion of an apparatus of the present disclosure.

FIG. 2E is a front view of an exemplary embodiment of an apparatus of the present disclosure coupled around an entry point of a structure with the gate in a third position.

FIG. 2F is a perspective view of an exemplary embodiment of an apparatus of the present disclosure.

FIG. 2G is a top view of an exemplary embodiment of an apparatus of the present disclosure.

FIG. 2H is a side view of an exemplary embodiment of a frame member and cover portion of an apparatus of the present disclosure.

FIG. 3A is a front perspective view of an exemplary embodiment of an apparatus of the present disclosure coupled around an entry point of a structure with the gate in a first position.

FIG. 3B is a side view of an exemplary embodiment of an apparatus of the present disclosure coupled around an entry point of a structure with the gate in a first position.

FIG. 3C is a top view of an exemplary embodiment of an apparatus of the present disclosure coupled around an entry point of a structure with the gate in a first position.

FIG. 3D is a front view of an exemplary embodiment of an apparatus of the present disclosure coupled around an entry point of a structure with the gate in a first position.

FIG. 4A is a front perspective view of an exemplary embodiment of an apparatus of the present disclosure coupled around an entry point of a structure with the gate in a first position.

FIG. 4B is a side view of an exemplary embodiment of an apparatus of the present disclosure coupled around an entry point of a structure with the gate in a first position.

FIG. 4C is a top view of an exemplary embodiment of an apparatus of the present disclosure coupled around an entry point of a structure with the gate in a first position.

FIG. 5 is an of an exemplary embodiment of an apparatus of the present disclosure for pet door entrance gate security.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being in communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

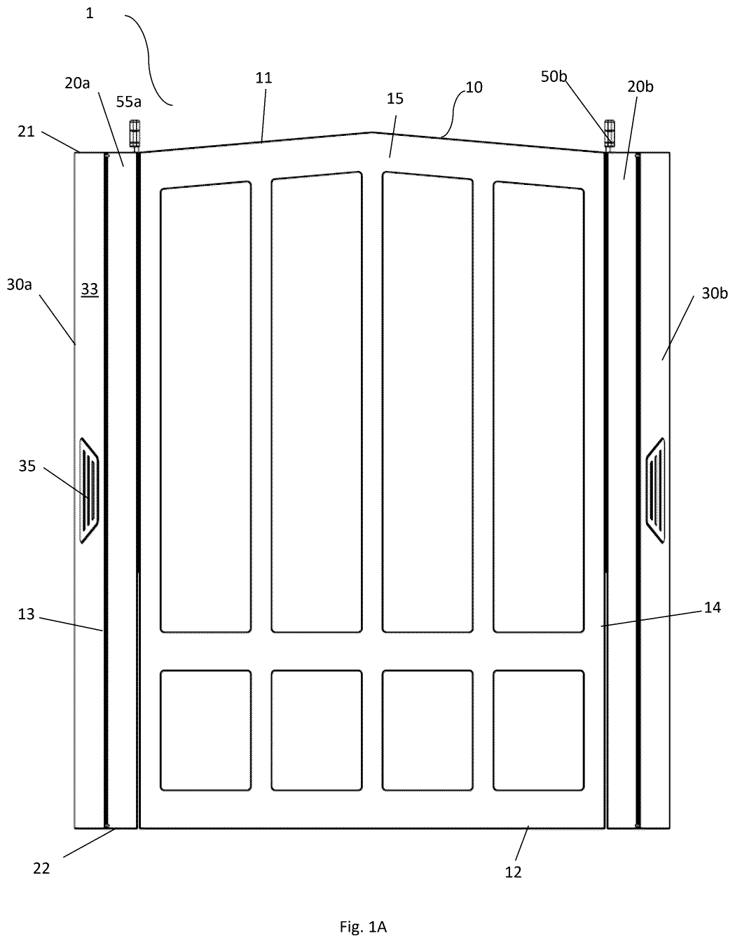

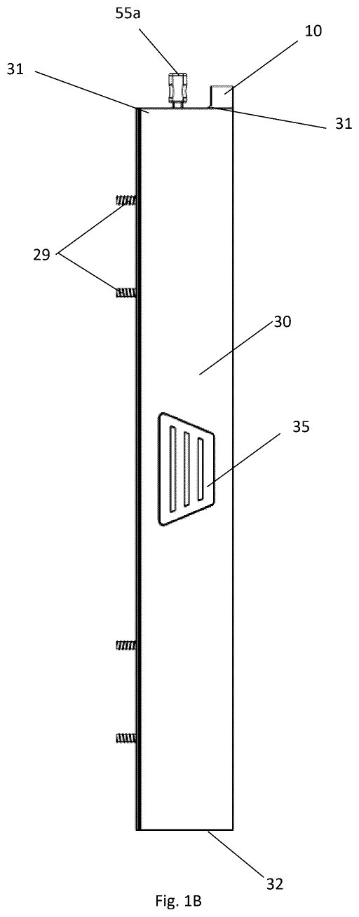

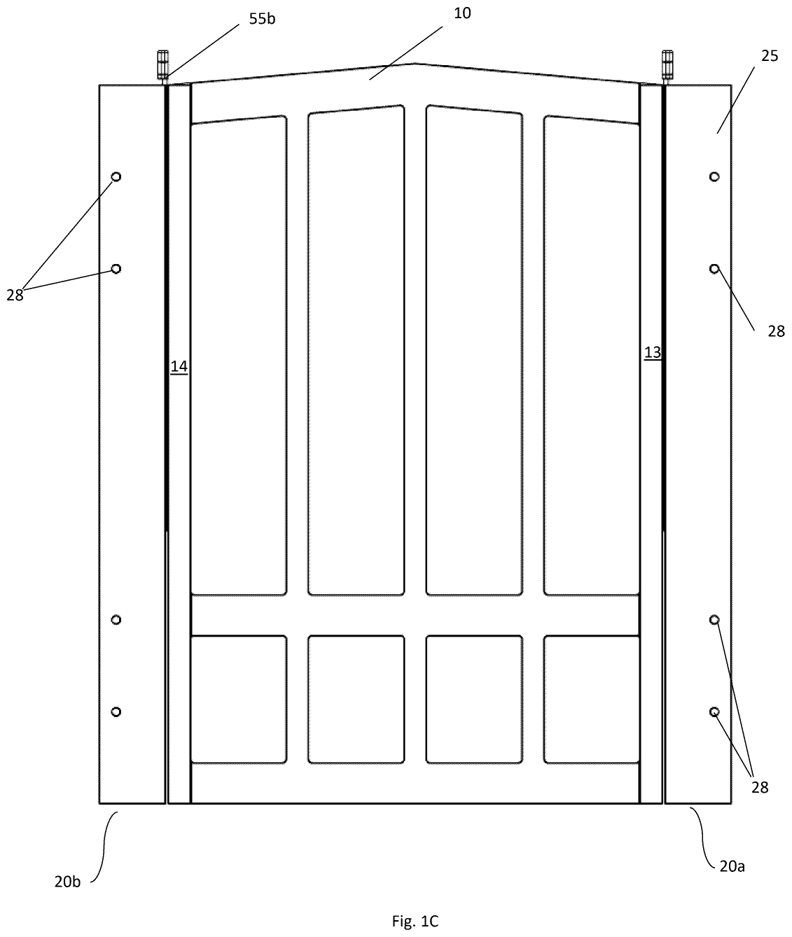

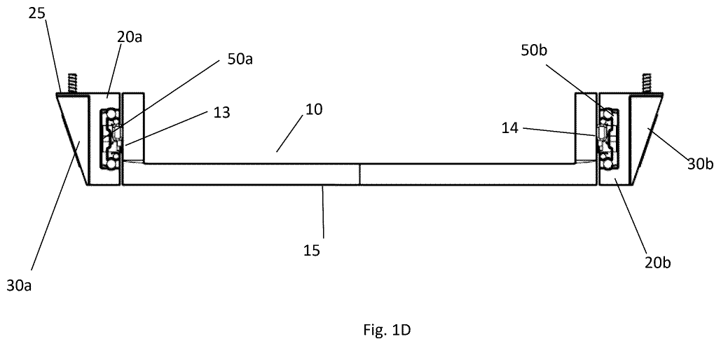

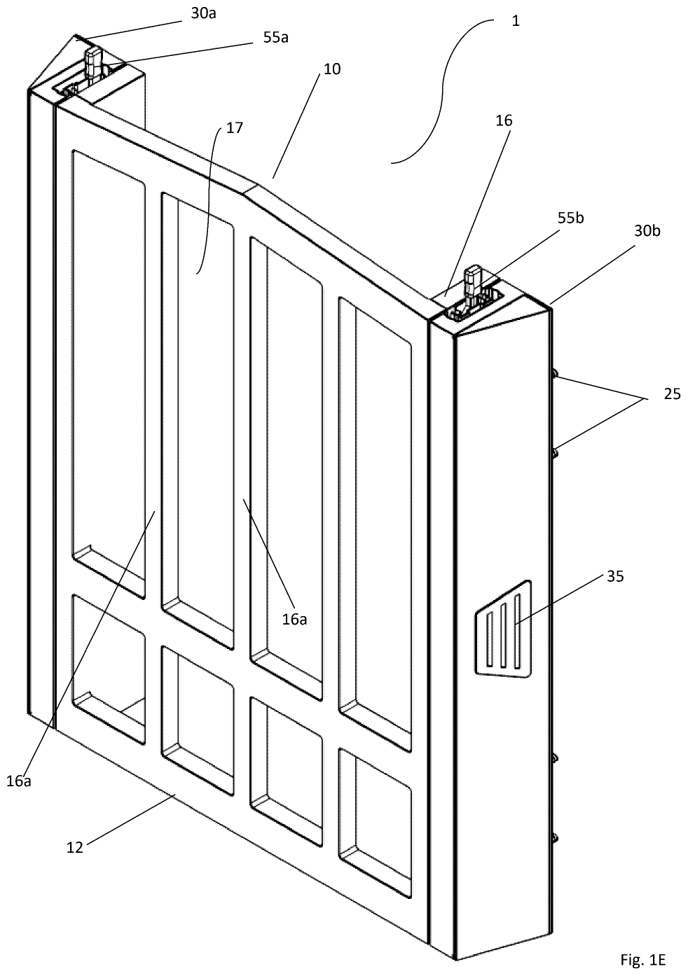

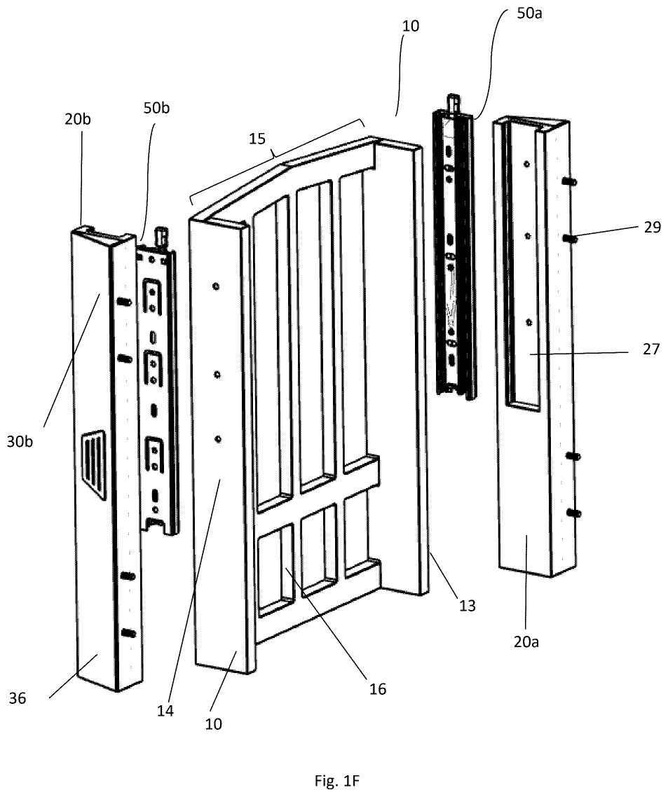

Referring now to FIGS. 1-5 of a door attachment apparatus according to the present disclosure can have various components. In one exemplary embodiment, an apparatus 1 of the present disclosure can generally comprises a frame having sidewalls of frame portions 20 and a removeable gate portion 10. The gate portion 10 can include a first end or top end 11 and a bottom end 12 that can define the height of the gate portion 10. The gate portion 10 can include a first sidewall 13 and a second sidewall 14 that can fit between the two frame portions 20 and define a width of the gate portion 10. The intermediate portion 15 can span between the first sidewall 13 and the second sidewall 14. In one exemplary embodiment, a gate portion 10 can be generally slidably coupled between the two frame portions 20. The frame portions 20 have a first end 21, a second end 22, a first side wall 23a, and a second sidewall 23b. Additional sidewalls can be used to form a rectangular frame structure as shown in FIG. 1G. A flange portion 25 can extend generally perpendicular from one or more of the side walls 23. The flange portion can have one or more apertures 28 or location points marked to provide mounting points for the frame portions 20 to a structure 100. The frame portions 20 can be mounted to a structure 100 using any suitable means including but not limited to an adhesive or fasteners 29. The structure 100 can be a wall, door, cabinet, or other suitable structure for the apparatus 1. In some uses, the apparatus can be used as a security gate for a pet or animal opening 101 formed on the structure 100 to prevent unwanted entry of other animal or intruders. Similarly, the apparatus 1 could be applied to or near windows for security purposes such as a mobile home window or other access points within a structure. The gate portion 10 can take any suitable shape and construction. In some exemplary embodiments, the gate portion 10 can have one or more slats 16 spaced a predetermined distance from each other. In other embodiments, the gate portion 10 can be a solid construction with no pass through areas 17. The construction of the apparatus 10 can allow a user to utilize multiple types of gate portions 10 depending upon the desired use. In some instances, the apparatus can include multiple types of gate portions, including a slat model, a full panel, and/or an insulated gate portion. Similarly, the gate portion can be potentially modular to allow for various size opening to be accommodated. By having a first frame portion and a second frame portion positioned on either side of the desired opening of the structure, a modular gate can reduce the amount of different components that need to be provided and allow for easier and more wide range of opening. Alternatively, the gate portion can have various widths to accommodate various opening sizes. This eliminates the need of a complete frame that surround all side of the opening 101.

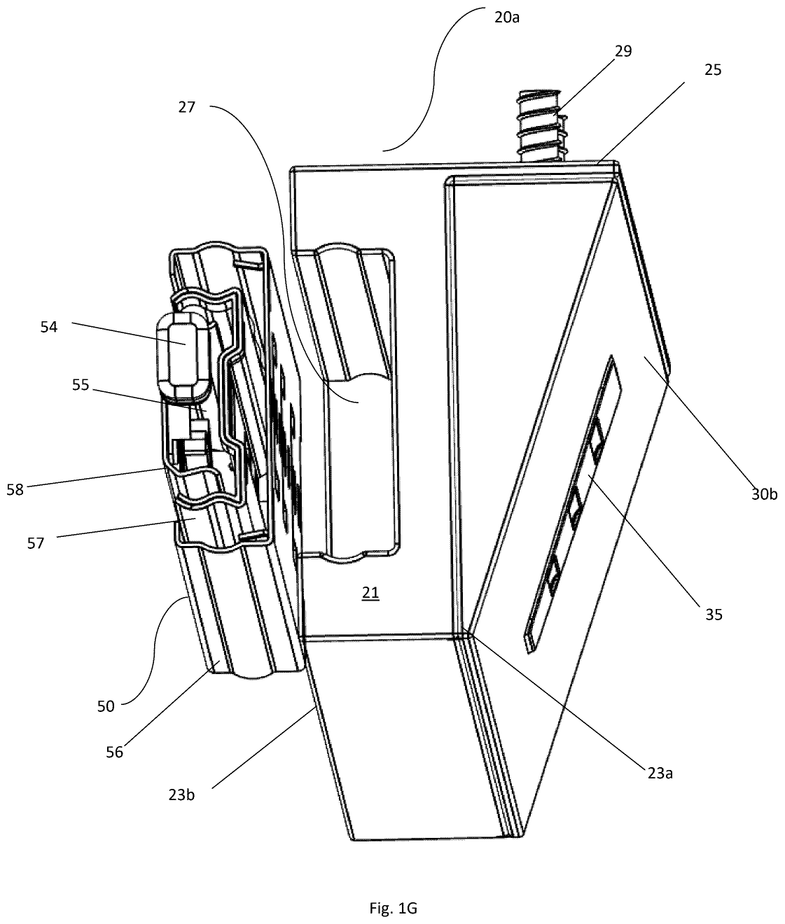

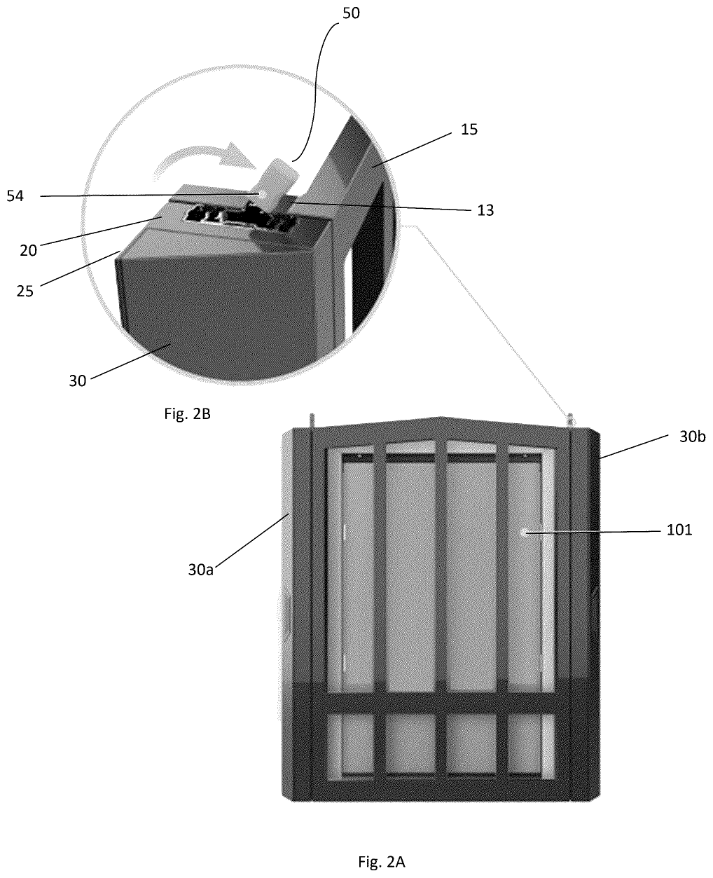

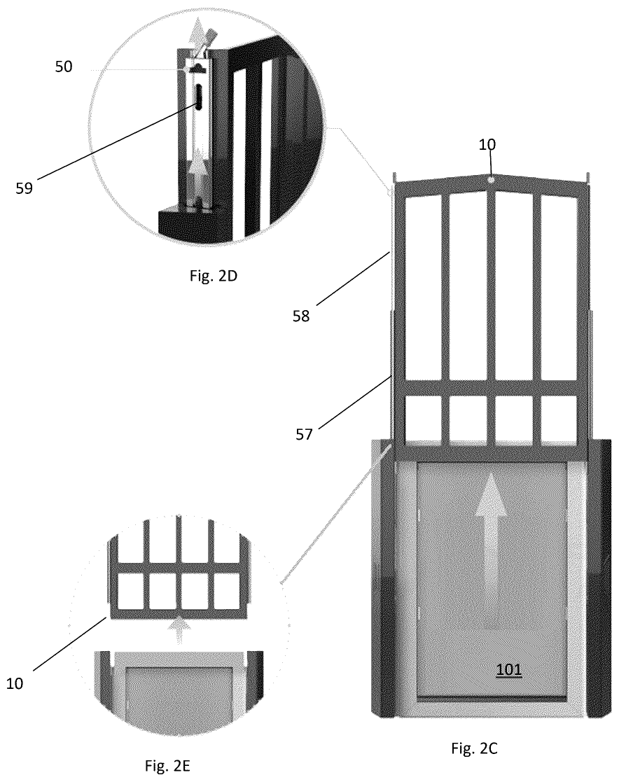

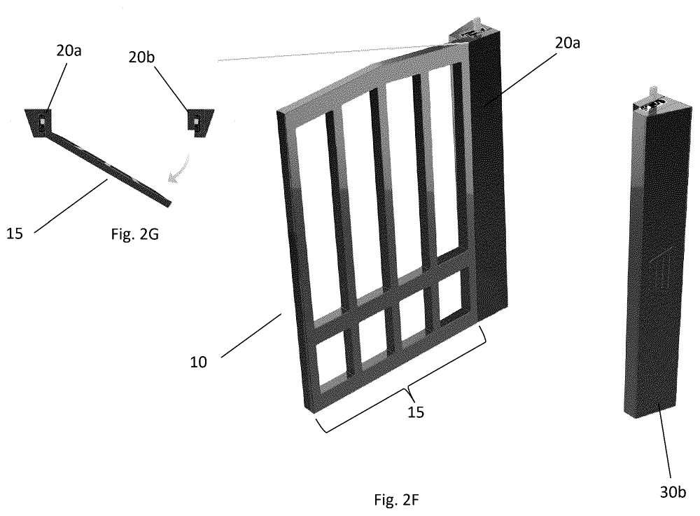

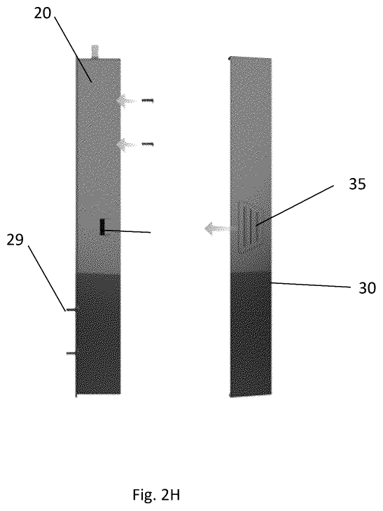

As shown in FIGS. 1-2, some exemplary embodiments, the apparatus 30 can include a sliding mechanism 50 such as a moveable track/sliding assembly that can be positioned within a cavity or channel 27. The channel 27 can be formed to approximate the shape of the respective moveable track system 50 as shown in FIG. 1G. As shown in FIG. 1F, a first track system 50a can correspond to a first frame portion 20a and a second track system 50b can correspond to a second frame portion 20b. The track system 50 can include a first track portion 56 that can be coupled to the frame portion on a first side. The first track portion 56 can have one or more apertures to provide for mounting the apparatus to the respective frame portion 20. A second track portion 57 can be slidably housed within the first track portion 56. The second track portion 57 can be at least partially housed and fully removed from the first track portion 56. A third track portion 58 can be at least partially housed within the second track portion 57. The third track portion 58 can be slidable within the second track portion 57. The third track portion 58 can be removably coupled to a first side or portion of the gate portion 10. As shown in FIG. 2D, a track portion can have an aperture 59 to provide coupling point to the gate portion 10. This configuration allows for the gate to be slidable along a vertical axis as shown in FIG. 2C. The gate portion can be further fully removed from between the frame portions at the first track portion 56. This can allow a user to easily remove the gate portion 10 when desired. FIG. 2A provides the gate in a first position without the track portions being slid vertically.

FIG. 2C illustrates the gate portion moved to a second position when the track portions 57,58 are fully extended. As shown, the second track portion is fully extend out of the first track portion 56 wherein only a small portion is still housed within the first frame portion 56 and the third track portion 58 is fully slidably extended from the second track portion 57 wherein only a portion of the third track portion 58 remains housed within the second track portion. It should be understood that in some configurations, the apparatus 1 may only have a first and second track portion. In those configurations, the second track portion can be removably coupled to a portion of the gate portion 10. In some exemplary embodiments, the track systems 50 can include ball bearing slides similar to those used for drawers. Ball bearings can be utilized to improve smooth movement when sliding along the vertical axis. As shown in FIG. 2E, the gate can be fully removed from the respective frame and track portions. As previously mentioned, this can allow a user to easily change the type or structure of the gate portion 10, as user can easily couple the respective track portions to the sides of the gate portion and slide back into the first track portion 56 for continued use.

The track system 50 can further include a locking mechanism 55 to prevent or limit movement of the gate along the vertical axis. The locking mechanism 55 can be moved from a first unlocked position to a second locked position to stop movement of the gate 10. This can prevent a third party from trying to move the gate when in a locked position providing additional security. The locking mechanism 55 can take any suitable configuration, including but not limited to a switch or tab 54 that can be moved between a first and second position as shown in FIG. 2B. In some exemplary embodiments, at least two locking tabs located at a top end of the two sidewalls and cooperatively coupled to the gate. The locking tab 54 may be manually operable by a user and configured to lock/unlock the sliding mechanism when the user pushes the locking tab forwards/backwards. The locking mechanism 55 may be used to lock the gate at an open position, when the gate is located above the top end of the sidewalls and above the existing pet door or opening. Track system provides smooth operation of lifting the gate and locking it into one or more locations by a user. The locking system/mechanism 55 can be a gate latch lock system having a slide lock hook 53 that can secure the gate portion from sliding up vertically or rotating around the axis having a hinge connection.

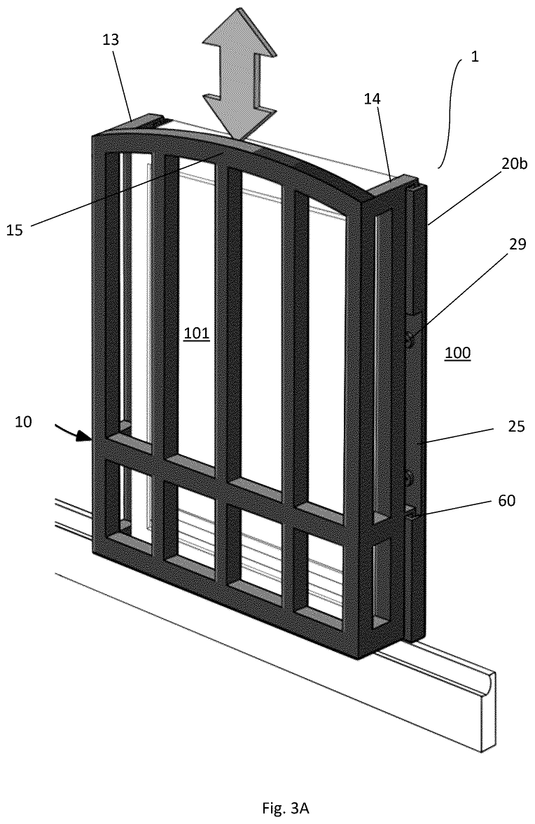

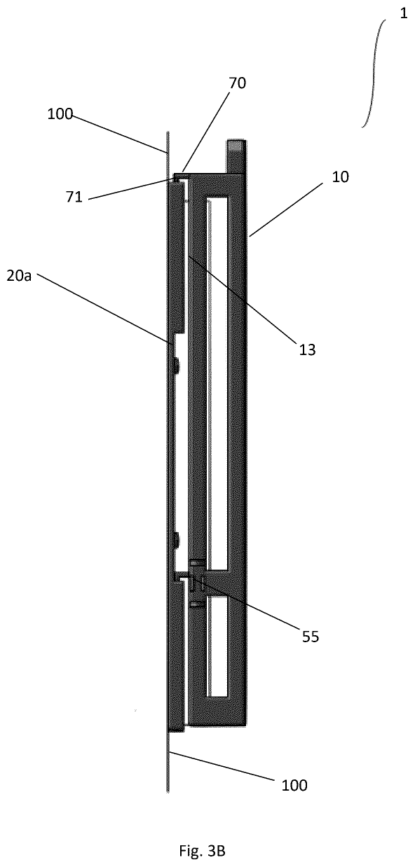

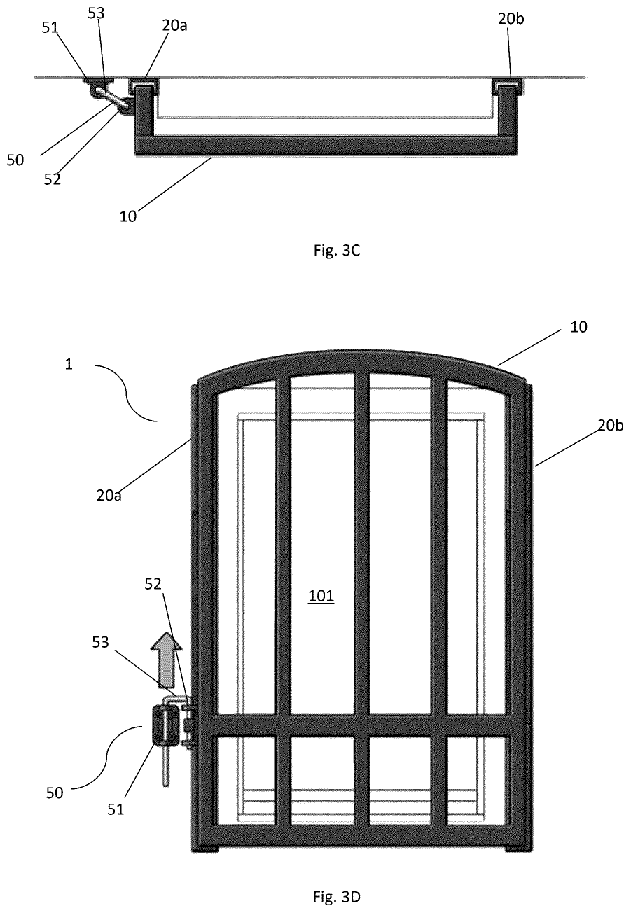

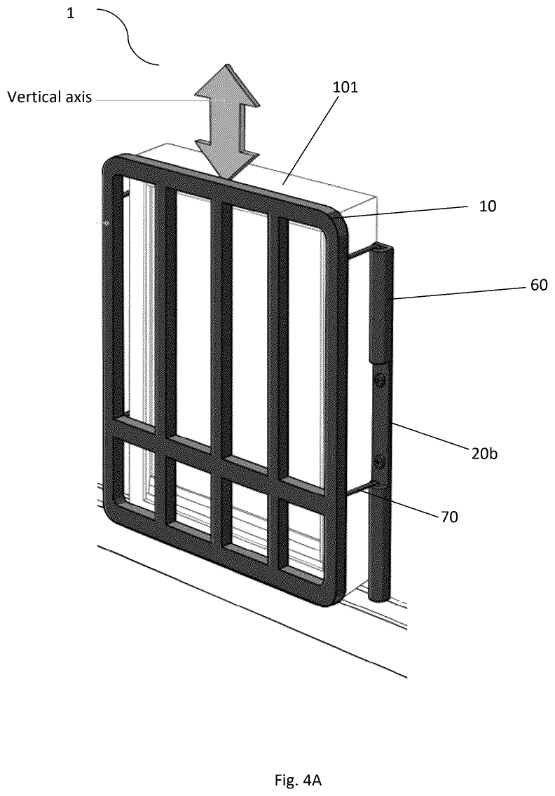

As shown in FIGS. 2F-G, in some exemplary embodiments of the apparatus 1, a gate portion 10 can have a hinge along a first axis. In some embodiments, the intermediate portion 15 can be hingedly coupled to a sidewall 13,14 of the gate portion 10. This can provide a user to move the gate along a vertical axis as well as open rotatably around a first axis. This provides a user additional functionality to utilize the gate in various applications that may not allow for the gate to be slidably opened including but not limited to under a countertop, near a ceiling, etc. The apparatus 1 may further comprise a swing gate located between the sidewalls 13,14 and configured for swinging between an open and closed position. Alternatively, the removeable gate 10 may be couplable to the frame via hinges and the gate may be configured to swing around the frame, between an open and closed position. The apparatus can be made of lightweight and durable material, such as hollow stainless-steel frame. The swing gate intermediate portion 15 may be made of a flexible material, such as plastic. The apparatus may be made in various shapes and sizes. The swing gate can similarly have a latching mechanism to lock the gate. In some instances, it can be a magnetic latch wherein a portion or side 19 of the intermediate portion removably couples a sidewall 13,14 of the frame portion 10. Other latching mechanisms can include a pivot member latch similar to the latch shown in FIG. 3C that can keep the hingedly connected portion from opening.

The apparatus can further optionally include one or more cover portions 30. The cover portions 30 can be removably coupled to a respective frame portion 20. As illustrated in FIG. 1A, a first cover portion 30a can be removably coupled to the first frame portion 20a and second cover portion 30b can be removably coupled to a second frame portion 20b. The cover portions 30 can be coupled using any suitable means, including but not limited to fasteners or pressure/friction fit on to the frame portions. Alternatively, the frame portion 20 can have a clip 39 to couple to the cover portion 30. The cover portions 30 can have a grip member 35 on an exterior surface 33 to allow a user to easily grab and remove the cover portions when desired. The cover portion can cover the flange portion 25 of the frame portion 20 to hide any mounting fasteners 29 that may be used as well as providing a better aesthetic appearance. The cover portions 30 can take any suitable shape. In some exemplary embodiments, the exterior surface can be angular or chamfered to provide smoother transition to prevent injury from contacting the edge or surface of the apparatus 1 on the side.

FIGS. 3A-D illustrate an exemplary embodiment of an apparatus 1 of the present disclosure illustrates an embodiment comprising a gate portion 10 and a first frame portion 20a and a second frame portion. The first frame portion 20a can be positioned on a first side of an opening and the second frame portion 20b can be positioned on a second side of an opening 101. The frame portions 20 can be coupled to a structure or wall 101 with one or more fasteners 29. The frame portions 20 can each have one or more coupling interfaces 60. The gate portion can similarly have one or more arm members 70 that can extend from the side 13 of the gate portion 10. The arm member(s) 70 can extend generally perpendicularly from the backside of the sidewall 13,14 of the gate portion as shown in FIG. 3B. A corresponding pin portion 71 can extend generally perpendicular downward from the arm member 70. The pin portion can fit within the coupling interfaces 60 to hold the gate into place. The coupling interfaces 60 can be tubing having an aperture. In some exemplary embodiments, the coupling interfaces 60, arm 70, and pin portions 71 are only on one frame portion or member 20. The pin portion on one side can be longer that the pin portion on the opposite side of the gate portion. This can allow a user to lift and pivot the gate portion 10. The gate portion 10 can pivot on the coupling interfaces and pin members to allow the gate 10 to pivot on a first axis. Additionally, the gate can be lifted vertically to remove it from the frame portions 20. A locking mechanism 50 can be used to keep the gate from being removed. In one exemplary embodiments, the locking mechanism or lock 50 can be a pivot pin lock as shown in FIG. 3D. The pivot pin lock mount 51 can be mounted to a portion of the frame member or the wall. The gate portion 10 can include a coupling portion or aperture to allow a pin 53 to be lifted in and out of the locking aperture 52. Any other suitable locking mechanism may also be utilized including a magnetic lock, a latch, a hook and loop fastener strap.

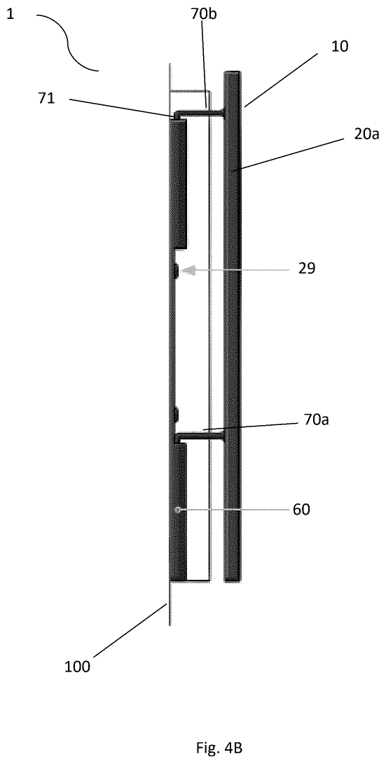

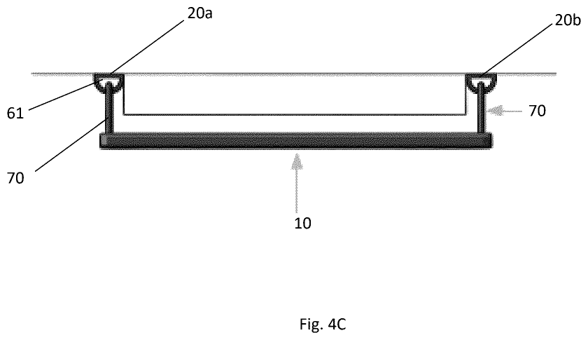

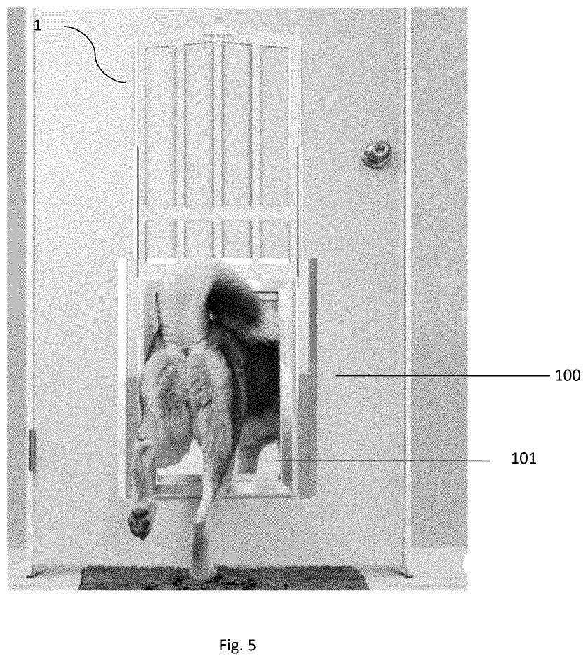

FIGS. 4A-C provide an exemplary embodiment for vertical removal having a first frame portion 20a and second frame portion 20b. The frame portions can be couple to a structure as previously recited using one or more fasteners 29. The gate portion can have corresponding arms 70 and pin portion 71. The frame portions can include one or more coupling interfaces 60 that can include an aperture 61 to house the pin portions 71 as shown in FIG. 4C. The apparatus of the present disclosure can be used for multiple applications including but not limited to a ped door gate to prevent the entrance of animals or people when the house or dwelling is empty. The apparatus 1 can be adapted to work the preexisting openings 101 as shown in FIG. 5.

The components of the present disclosure can be comprised of any suitable materials including metal, alloy, polymers, plastics, or other rigid material for providing a security. Various different materials can be used for various components. In some embodiments, the frame portion and gate portion can be comprised of metal or rigid polymer. The cover portions can be comprised of a plastic or polymer material, or alternatively metal or word or other suitable material.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A security door apparatus for an opening to a structure, comprising:
a gate portion, wherein the gate portion comprises a first sidewall, a second sidewall, and an intermediate portion positioned between the first sidewall and second sidewall;
a first frame portion, having a first end, a second end, and a flange portion, wherein the first end and second end define the length of the first frame portion; and
a second frame portion, having a first end, a second end, and a flange portion, wherein the first end and second end define the length of the first frame portion,
wherein the first frame portion is positioned on a first side of the opening and coupled to the structure and the second frame is positioned on a second side of the opening and coupled to the structure,
wherein the gate portion is removably coupled to the first frame portion and second frame portions and is configured to move between a first position and a second position on a vertical axis.

2. The security door apparatus of claim 1, wherein the first frame portion includes a first sliding assembly and the second frame portion include a second sliding assembly.

3. The security door apparatus of claim 2, wherein a first side of the first sliding assembly is removably coupled to a first side of the first frame portion and the second side of the first sliding assembly is removably coupled to the first sidewall of the gate portion, and wherein a first side of the second sliding assembly is removably coupled to a first side of the second frame portion and the second side of the second sliding assembly is removably coupled to the second sidewall of the gate portion.

4. The security door apparatus of claim 3, wherein the sliding assembly further comprises a locking member, wherein the locking member prevents the sliding assembly from moving along the vertical axis.

5. The security door apparatus of claim 4, wherein the locking member includes a tab that can be moved from a first locked position to a second unlocked position.

6. The security door apparatus of claim 5, wherein each sliding assembly comprises a first track portion, a second track portion, and a third track portion.

7. The security door apparatus of claim 6, wherein each frame portion comprises a channel configured to house the corresponding sliding assembly.

8. The security door apparatus of claim 7, wherein the first track portion is coupled to the sidewall of the cavity of the frame portion and the third track portion is coupled to a sidewall of the gate portion.

9. The security door apparatus of claim 6, wherein the second track portion is at least partially housed within the first track portion and the third track portion is at least partially housed within the second track portion.

10. The security door apparatus of claim 5, further comprising a first wall mount cover and a second wall mount cover, wherein the first wall mount cover is removably couplable to the first frame portion and the second wall mount cover is removably couplable to the second frame portion.

11. The security door apparatus of claim 5, wherein the intermediate portion of the gate portion is hingedly coupled to a first sidewall of the gate portion on at least one side, wherein the intermediate portion is configured to swing around a vertical axis.

12. The security door apparatus of claim 11, further comprising a first wall mount cover and a second wall mount cover, wherein the first wall mount cover is removably couplable to the first frame portion and the second wall mount cover is removably couplable to the second frame portion.

13. A security door apparatus for an opening to a structure, comprising:
a gate portion, wherein the gate portion comprises a first sidewall, a second sidewall, and an intermediate portion positioned between the first sidewall and second sidewall;
a first frame portion, having a first end, a second end, and a flange portion, wherein the first end and second end define the length of the first frame portion; and
a second frame portion, having a first end, a second end, and a flange portion, wherein the first end and second end define the length of the first frame portion,
a first wall mount cover and a second wall mount cover, wherein the first wall mount cover is removably couplable to the first frame portion and the second wall mount cover is removably couplable to the second frame portion;
wherein the first frame portion is positioned on a first side of the opening and coupled to the structure and the second frame is positioned on a second side of the opening and coupled to the structure,
wherein the gate portion is removably coupled to the first frame portion and second frame portions and is configured to move between a first position and a second position on a vertical axis,
wherein the first frame portion includes a first sliding assembly, and the second frame portion includes a second sliding assembly,
wherein a first side of the first sliding assembly is removably coupled to a first side of the first frame portion and the second side of the first sliding assembly is removably coupled to the first sidewall of the gate portion, and wherein a first side of the second sliding assembly is removably coupled to a first side of the second frame portion and the second side of the second sliding assembly is removably coupled to the second sidewall of the gate portion.

14. The security door apparatus of claim 13, wherein the intermediate portion of the gate portion is hingedly coupled to a first sidewall of the gate portion on at least one side, wherein the intermediate portion is configured to swing around a vertical axis.
